(19) United States
(12) Patent Application Publication
(10) Pub. No.: US 2015/0315021 A1
(43) Pub. Date: Nov. 5, 2015

(54) METHOD FOR PRODUCING CHLORINE

(71) Applicant: SUMITOMO CHEMICAL COMPANY, LIMITED, Tokyo (JP)

(72) Inventor: Junichi NISHIMOTO, Chuo-ku, Tokyo (JP)

(73) Assignee: SUMITOMO CHEMICAL COMPANY, LIMITED, Chuo-ku, Tokyo (JP)

(21) Appl. No.: 14/647,658

(22) PCT Filed: Nov. 15, 2013
(86) PCT No.: PCT/JP2013/081458

§ 371 Date: May 27, 2015

(30) Foreign Application Priority Data
Nov. 28, 2012 (JP) 2012-259419

(51) Int. Cl. C01B 7/04; B01J 35/00; B01J 21/06; B01J 23/46; B01J 21/08

(52) U.S. Cl. CPC C01B 7/04; B01J 23/462; B01J 21/08; B01J 21/063; B01J 35/0006

(57) ABSTRACT

To provide a method for producing chlorine in which catalytic activity can be retained stably over a long period of time even when hydrogen chloride and oxygen both containing a sulfur component are used, thus satisfactorily enabling continuous oxidation reaction. The method for producing chlorine includes bringing a mixed gas containing hydrogen chloride, oxygen, and a sulfur component into contact with a supported ruthenium oxide including ruthenium oxide and silica supported on a titania carrier to thereby oxidize hydrogen chloride in the mixed gas with oxygen, wherein the supported ruthenium oxide is obtained by performing a contact treatment of the titania carrier with an alkoxysilane compound, drying in a steam-containing gas flow, performing first calcination in an oxidizing gas atmosphere, performing a contact treatment of the sold including silica supported on the titania carrier with a ruthenium compound, and performing second calcination in an oxidizing gas atmosphere.

### TECHNICAL FIELD

The present invention relates to a method for producing chlorine by oxidizing hydrogen chloride with oxygen.

### BACKGROUND ART

Chlorine is useful as raw materials of vinyl chloride, phosgene, and the like. A method utilizing an oxidation reaction is known as the method for producing the same. That is, it is a method in which a hydrogen chloride gas is brought into contact with oxygen in the presence of a catalyst to thereby oxidize the hydrogen chloride to obtain chlorine.

Meanwhile, the hydrogen chloride and oxygen may sometimes contain a sulfur component resulted from a generation source thereof. If the hydrogen chloride and oxygen contain a sulfur component, the sulfur component bringing a poison in a catalyst is accumulated on a surface of a catalyst, leading to deterioration of catalytic activity. Therefore, there arises a need to refill the catalyst, thus failing to stably react over a long period of time. JP 2010-105857 A and JP 2011-121845 A disclose, as a method for solving these problems, a method for producing chlorine in which using a supported ruthenium oxide catalyst obtained by bringing a titania carrier into contact with an alkoxysilane compound, followed by air drying, calcining in air, bringing into contact with a ruthenium compound and further calcining in air, and alumina having a high specific surface area, γ-alumina having a high specific surface area is allowed to adsorb and absorb a sulfur component, and then hydrogen chloride in a mixed gas containing hydrogen chloride, oxygen, and a sulfur component is oxidized with oxygen while suppressing poisoning of the catalyst.

### DISCLOSURE OF THE INVENTION

### Problems to be Solved by the Invention

However, in the above-mentioned conventional production methods, since removal of the sulfur component by alumina having a high specific surface area becomes indispensable, these methods were are not always satisfactory in aspects of operation cost and facility cost.

An object of the present invention is to provide a method for producing chlorine in which catalytic activity can be retained stably over a long period of time even when hydrogen chloride and oxygen both containing a sulfur component are used, thus satisfactorily enabling continuous oxidation reaction.

### Means for Solving the Problems

The present inventors have intensively studied so as to achieve the above object, thus completing the present invention.

That is, the present invention includes the following embodiments.

[1] A method for producing chlorine, which includes bringing a mixed gas containing hydrogen chloride, oxygen, and a sulfur component into contact with a supported ruthenium oxide including ruthenium oxide and silica supported on a titania carrier to thereby oxidize hydrogen chloride in the mixed gas with oxygen, wherein the supported ruthenium oxide is obtained by performing a contact treatment of the titania carrier with an alkoxysilane compound, drying in a steam-containing gas flow, performing first calcination in an oxidizing gas atmosphere, performing a contact treatment of the sold including silica supported on the titania carrier with a ruthenium compound, and performing second calcination in an oxidizing gas atmosphere.

[2] The method according to the above [1], wherein the space velocity of the steam-containing gas in the titania carrier is 10 to 2,000/h in a standard state during drying.

[3] The method according to the above [1] or [2], wherein the contact treatment with the ruthenium compound is a contact treatment with a solution containing a ruthenium compound and a solvent and, after the contact treatment with the solution containing a ruthenium compound and the solvent, drying is performed until the content of the solvent becomes 0.10 to 15% by weight based on the weight of the solid, and then the obtained dried product is subjected to the second calcination.

[4] The method according to the above [3], wherein the dried product is retained in a state where the solvent is contained in a proportion of 1.0 to 15% by weight based on the weight of the solid, and then the second calcination is performed.

[5] The method according to the above [4], wherein an evaporation rate of the solvent is less than 0.01 g/h per 1 g of the solid during retention.

[6] The method according to the above [4] or [5], wherein the retention is performed for 10 hours or more.

### Effects of the Invention

According to the present invention, catalytic activity can be retained stably over a long period of time even when hydrogen chloride and oxygen both containing a sulfur component are used, thus satisfactorily enabling continuous oxidation reaction.

### MODE FOR CARRYING OUT THE INVENTION

The present invention will be described in detail below. In the present invention, chlorine is produced by bringing a mixed gas containing oxygen and a sulfur component into contact with a supported ruthenium oxide including ruthenium oxide and silica supported on a titania carrier to thereby oxidize hydrogen chloride in the mixed gas with oxygen.

In the present invention, the supported ruthenium oxide is obtained by performing a contact treatment of a titania carrier with an alkoxysilane compound, drying in a steam-containing gas flow, performing first calcination in an oxidizing gas atmosphere, performing a contact treatment with a ruthenium compound, and performing second calcination in an oxidizing gas atmosphere.

The titania carrier is made of a rutile type titania (titania having a rutile type crystal structure), an anatase type titania (titania having an anatase type crystal structure), an amorphous titania, or the like, or may be made of a mixture thereof. In the present invention, a titania carrier made of a rutile type titania and/or an anatase type titania is preferable. Of these, the titania carrier is preferably a titania carrier in which a ratio of the rutile type titania to the rutile type titania and the anatase type titania in the titania carrier (hereinafter sometimes referred to as a rutile type titania ratio) is 50% or more, more preferably a titania carrier in which the rutile type titania ratio is 70% or more, and still more preferably a titania carrier in which the rutile type titania ratio is 90% or more. As the rutile type titania ratio increases, thermal stability of the obtained supported ruthenium oxide tends to be improved, and thus catalytic activity becomes more satisfactory. A ratio of the rutile type titania ratio can be measured by an X-ray diffraction method (hereinafter referred to as an XRD method) and is represented by the following equation (1).

Rutile type titania ratio [%]=[IR/(IA+IR)]×100 (1)

IR: Intensity of diffraction line which represents a rutile type titania (110) plane
IA: Intensity of diffraction line which represents an anatase type titania (101) plane

The content of sodium in the titania carrier is preferably 200 ppm by weight or less, and the content of calcium is preferably 200 ppm by weight or less. Furthermore, the content of all alkali metal elements in the titania carrier is more preferably 200 ppm by weight or less, and the content of all alkali earth metal elements in the titania carrier is more preferably 200 ppm by weight or less. The contents of these alkali metal element and alkali earth metal element can be measured, for example, by a high-frequency inductively coupled plasma emission spectrometric analysis method (hereinafter sometimes referred to as an ICP analysis method), an atomic absorption spectrophotometric analysis method, an ion chromatographic analysis method, and the like, and preferably an ICP analysis method. The titania carrier may contain, in addition to titania, oxides such as α-alumina, silica, zirconia, and niobium oxide. It is preferred that the titania carrier does not substantially contain alumina having a high specific surface area. If alumina having a high specific surface area exists in the titania carrier, the sulfur component and oxidized sulfur component are likely to be adsorbed and/or absorbed on the supported ruthenium oxide and activity of the catalyst, so that activity of the catalyst sometimes deteriorates. Since α-alumina has a low BET specific surface area, adsorption and/or absorption of the sulfur component and oxidized sulfur component is/are less likely to occur. In other words, the above-mentioned problem is less likely to occur even if the carrier contains α-alumina. Examples of the alumina having a high specific surface area include alumina having a specific surface area of 10 to 500 m²/g, and preferably 20 to 350 m²/g. The specific surface area of alumina can be measured by a nitrogen adsorption method (BET method) and is usually measured by a BET single point method.

The specific surface area of the titania carrier can be measured by a nitrogen adsorption method (BET method) and is usually measured by a BET single point method. The specific surface area obtained by the measurement is preferably 5 to 300 m²/g, and more preferably 5 to 50 m²/g. If the specific surface area is too high, the titania carrier and ruthenium oxide in the obtained supported ruthenium oxide may be likely to be sintered, leading to deterioration of thermal stability. Meanwhile, if the specific surface area is too low, ruthenium oxide in the obtained supported ruthenium oxide may be less likely to be dispersed, leading to low catalytic activity.

Silica is supported on the titania carrier by performing a contact treatment of the titania carrier with an alkoxysilane compound, followed by drying in a steam-containing gas flow and further first calcination in an oxidizing gas atmosphere. Examples of the alkoxysilane compound include tetraalkoxysilane, alkylalkoxysilane, phenylalkoxysilane, halogenated alkoxysilane, and the like. Of these, tetraalkoxysilane is preferred. Examples of the tetraalkoxysilane include tetramethoxysilane, tetraethoxysilane, tetrapropoxysilane, tetraisopropoxysilane, tetrabutoxysilane, and the like. Of these, tetraethoxysilane is preferred. Examples of the alkylalkoxysilane include methyltrimethoxysilane, dimethyldimethoxysilane, methyltriethoxysilane, and the like. Examples of the phenylalkoxysilane include phenyltrimethoxysilane, phenyltriethoxysilane, and the like. Examples of the halogenated alkoxysilane include SiCl(OR)₃ (hereinafter R represents an alkyl group), SiCl₂(OR)₂, SiCl₃(OR), and the like. If necessary, a hydrate of the alkoxysilane compound may also be used, or two or more alkoxysilane compounds may also be used. The amount of the alkoxysilane compound to be used is preferably 0.0005 to 0.15 mol, more preferably 0.0010 to 0.10 mol, based on 1 mol of titania in the titania carrier. When using two or more silicon compounds, the total amount of the silicon compounds to be used may fall within the above range based on titania in the titania carrier.

The contact treatment of the titania carrier with the alkoxysilane compound is preferably performed by a contact treatment of the titania carrier with a solution prepared by dissolving the alkoxysilane compound in an alcohol and/or water (hereinafter sometimes referred to as an alkoxysilane compound solution). Examples of the alcohol include methanol, ethanol, and the like. Water is preferably high purity water such as distilled water, ion-exchange water, or ultrapure water. If water to be used contains numerous impurities, such impurities may sometimes adhere to the catalyst, leading to deterioration of activity of the catalyst. In the contact treatment, the temperature during the treatment is usually 0 to 100° C., and preferably 0 to 50° C., and the pressure during the treatment is usually 0.1 to 1 MPa, and preferably atmospheric pressure. Such contact treatment can be performed in an air atmosphere, or in an inert gas atmosphere such as nitrogen, helium, argon, or carbon dioxide, and the inert gas may contain steam.

Examples of the contact treatment include impregnation, immersion, and the like. Examples of the method for contact treatment of the titania carrier with the alkoxysilane compound solution include a method (A) in which a titania carrier is impregnated with an alkoxysilane compound solution, a method (B) a titania carrier is immersed in an alkoxysilane compound solution, and the like, and the method (A) is preferred. The alkoxysilane compound is supported on the titania carrier by the contact treatment.

The contact treatment of the titania carrier with the alkoxysilane compound is performed, followed by drying in a steam-containing gas flow. During the drying, the temperature is preferably 10° C. to 100° C., and the pressure is preferably 0.01 to 1 MPa, and more preferably atmospheric pressure. A steam-containing gas is a mixture of steam with the other gas and the concentration of steam of the steam-containing gas is set within a range of the amount of saturated steam of the other gas or less, under drying conditions. The concentration is preferably 0.5 to 10% by volume, and more preferably 1.0 to 5% by volume. The steam-containing gas is preferably a mixed gas of steam and an inert gas, and the concentration of steam can be adjusted by a mixing ratio of steam to the inert gas in the mixed gas, or adjusted by further mixing an oxidizing gas such as air, and an inert gas such as nitrogen, helium, argon, or carbon dioxide with the mixed gas. During the drying, the flow velocity of the steam-containing gas in the titania carrier is preferably 10 to 2,000/h, more preferably 100 to 1,000/h, and still more preferably 100 to 500/h, in a standard state (in terms of 0° C., 0.1 MPa), as the space velocity of the steam-containing gas (GHSV). The space velocity can be determined by dividing the amount of the steam-containing gas per 1 hour, which passes through a device for performing a drying treatment (L/h), by a titania carrier capacity (L) in a device for performing a drying treatment.

Drying is preferably performed while stirring. Drying while stirring means that the titania carrier after subjected to the contact treatment is not dried in a stationary state but in a flow state. Examples of the stirring method include a method of rotating a drying container itself, a method of stirring using a stirrer provided in a drying container, and the like.

After drying, first calcination is performed in an oxidizing gas atmosphere. The support alkoxysilane compound is converted into silica by the calcination. Examples of the oxidizing gas include an oxygen-containing gas. The oxygen concentration is usually about 1 to 30% by volume. Air and pure oxygen are usually used as the oxidizing gas and, if necessary, the oxidizing gas may be diluted with an inert gas and steam. The oxidizing gas is preferably air. The calcination temperature is usually 100 to 1,000° C., and preferably 250 to 450° C.

As mentioned above, silica is supported on the titania carrier and then ruthenium oxide is supported. Ruthenium oxide is supported on the solid obtained by supporting silica on the titania carrier (hereinafter sometimes referred to as a solid) by performing a contact treatment of the solid with a ruthenium compound, followed by second calcination in an oxidizing gas atmosphere.

Examples of the ruthenium compound include halides such as RuCl₃ and RuBr₃; halogeno-salts such as K₃RuCl₆ and K₂RuC1₆; oxo acid salts such as K₂RuO₄ and Na₂RuO₄; oxyhalides such as Ru₂OCl₄, Ru₂OCl₅, and Ru₂OCl₆; halogeno complexes such as K₂ [RuCl₅ (H₂O)₄], [RuCl₂ (H₂O)₄]Cl, K₂ [Ru₂OCl₁₀], and Cs2 [Ru₂OCl₄]; ammine complexes such as [Ru(NH₃)5H₂O]Cl₂, [Ru(NH₃)5Cl]Cl₂, [Ru(NH₃)₆]Cl₂, [Ru(NH₃)₆]Cl₃, and [Ru(NH₃)₆]Br₃; carbonyl complexes such as Ru(CO)₅ and Ru₃(CO)₁₂; carboxylate complexes such as [Ru₃O(OCOCH₃)₆(H₂O)₃]OCOCH₃ and [Ru₂(OCOR1)₄]Cl (R₁=an alkyl group having 1 to 3 carbon atoms); nitrosyl complexes such as K₂[RuCl₅(NO)], [Ru(NH₃)₅(NO)]Cl₃, [Ru(OH)(NH₃)₄(NO)] (NO₃)₂, and [Ru(NO)] (NO₃)₃; phosphine complexes, amine complexes, acetylacetonate complexes, and the like. Of these, halides are preferably used, and chlorides are particularly preferably used. If necessary, a hydrate of the ruthenium compound may also be used, or two or more ruthenium compounds may also be used.

The proportions of the solid including silica supported on a titania carrier and the ruthenium compound to be used may be appropriately adjusted so that the weight ratio (ruthenium oxide)/(solid including silica on a titania carrier) in the supported ruthenium oxide obtained after the below-mentioned second calcination becomes preferably 0.1/99.9 to 20.0/80.0, more preferably 0.3/99.7 to. 10.0/90.0, and still more preferably 0.5/99.5 to 5.0/95.0. Too small amount of ruthenium oxide may sometimes lead to insufficient catalytic activity, whereas, too large amount may sometimes lead to disadvantage in view of cost. In addition, the proportions of the ruthenium compound and solid to be used are preferably adjusted so that the content of ruthenium oxide is 0.10 to 20 mol based on 1 mol of silica supported on the solid, and more preferably 0.20 to 10 mol. Too high number of mols of ruthenium oxide based on 1 mol of silica may sometimes lead to deterioration of thermal stability of the supported ruthenium oxide, whereas, too low number of mols of ruthenium oxide may sometimes lead to deterioration of catalytic activity.

The contact treatment of the solid with the ruthenium compound is preferably performed by a contact treatment of the solid with a solution containing a ruthenium compound and a solvent. In the contact treatment, examples of the solvent include water, alcohol, nitrile, and the like. If necessary, two or more solvents may also be used. Water is preferably high purity water such as distilled water, ion-exchange water, ultrapure water, or the like. If water to be used contains numerous impurities, such impurities may sometimes adhere to the catalyst, leading to deterioration of activity of the catalyst. Examples of the alcohol include alcohols having 1 to 6 carbon atoms, such as methanol, ethanol, n-propanol, isopropanol, hexanol, and cyclohexanol. Examples of the nitrile include nitriles having 1 to 6 carbon atoms, such as acetonitrile, propionitrile, and benzonitrile. The amount of the solvent contained in the solution is preferably 70% by volume or more which is the amount calculated by removing the volume of the ruthenium compound to be supported from the total pore volume of the titania carrier to be used. There is no particular limitation on the upper limit. Too large amount of the solvent may tend to require a long period of time for drying, so that the upper limit is preferably about 120% by volume or less. In the contact treatment, the temperature during the treatment is usually 0 to 100° C., and preferably 0 to 50° C., and the pressure during the treatment is usually 0.1 to 1 MPa, and preferably atmospheric pressure. Such contact treatment can be performed in an air atmosphere, or in an inert gas atmosphere such as nitrogen, helium, argon, or carbon dioxide, and the inert gas may contain steam.

Examples of the contact treatment include impregnation, immersion, and the like. Examples of the method for contact treatment of the solid with the ruthenium compound include a method (C) in which a solid including silica supported on a titania carrier is impregnated with a solution containing a ruthenium compound and a solvent, a method (D) in which a solid including silica supported on a titania carrier is immersed in a solution containing a ruthenium compound and a solvent, and the like, and the method (C) is preferred. The ruthenium compound is supported on the solid by the contact treatment. When a contact treatment of the solid with a solution containing a ruthenium compound and a solvent is performed, in the mixture containing the ruthenium compound, the solvent, and the solid obtained after the contact treatment, the amount of the solvent to be used to the solid is preferably adjusted so that the content of the solvent exceeds 15% by weight based on the weight of the solid.

After the contact treatment of the solid with the ruthenium compound, drying may be performed, followed by second calcination in an oxidizing gas atmosphere, or drying may be performed, followed by a reduction treatment and further second calcination in an oxidizing gas atmosphere. A conventionally known method can be employed as such drying method, and the temperature is usually from room temperature to about 100° C., and the pressure is usually 0.001 to 1 MPa, and preferably atmospheric pressure. Drying can be performed in an air atmosphere, or in an inert gas atmosphere such as nitrogen, helium, argon, or carbon dioxide, and the inert gas may contain steam. Drying may be performed in a flow of air, an inert gas, or a mixed gas of air and an inert gas, and they may contain steam. When drying is performed in a steam-containing gas flow, the concentration of steam in the steam-containing gas is set within a range less than the amount of saturated steam of the gas containing steam, under drying conditions. When drying is performed in a gas flow, the flow velocity of the gas is preferably 10 to 10,000/h, and more preferably 100 to 5,000/h, in a standard state (in terms of 0° C., 0.1 MPa), as the space velocity of the gas (GHSV) in the solid. The space velocity can be determined by dividing the amount of the steam-containing gas per 1 hour, which passes through a device for performing a drying treatment (L/h), by a capacity (L) of the solid in a device for performing a drying treatment. Drying is preferably performed while stirring. The drying while stirring means that the solid after subjected to the contact treatment with the ruthenium compound is not dried in a stationary state but in a flow state. Examples of the stirring method include a method of rotating a drying container itself, a method of vibrating a drying container itself, a method of stirring using a stirrer provided in a drying container, and the like. Examples of the reduction treatment include reduction treatments mentioned in JP 2000-229239 A, JP 2000-254502 A, JP 2000-281314 A, JP 2002-79093 A, and the like.

When a contact treatment of the solid with a ruthenium compound is performed by a contact treatment of the solid with a solution containing a ruthenium compound and a solvent, drying (hereinafter sometimes referred to as a drying treatment) is preferably drying of the mixture containing a ruthenium compound, a solvent, and the solid obtained after the contact treatment until the content of the solvent becomes 0.10 to 15% by weight based on the weight of the solid. The drying treatment is preferably performed until the content of the solvent becomes 1.0 to 13% by weight, and more preferably 2.0 to 7.0% by weight, based on the weight of the solid. The content of the solvent in the dried product obtained after the drying treatment, on the basis of the weight of the solid, is calculated by the following equation (2).

Content (% by weight) of solvent based on weight of the solid in dried product=[amount (g) of residual solvent in dried product]/[amount (g) of the solid contained in dried product]×100 (2)

When a contact treatment of the solid with a solution containing a ruthenium compound and a solvent is performed by impregnation, the amount of the residual solvent in the dried product can be determined by subtracting the amount of change in weight of the ruthenium chloride-supported solid before and after a drying treatment from the amount of the solvent used in the contact treatment.

When a contact treatment of the solid with a ruthenium compound is performed by a contact treatment of the solid with a solution containing a ruthenium compound and a solvent, the drying speed during the drying treatment is appropriately set, and the evaporation rate of the solvent per 1 g of the solid is preferably 0.01 g/h or more, more preferably 0.02 g/h or more, and still more preferably 0.03 g/h or more, from the viewpoint of productivity. The upper limit of the drying speed is appropriately set, and the evaporation rate of the solvent per 1 g of the solid is preferably 0.50 g/h or less. Such drying speed can be controlled by adjusting conditions such as temperature, pressure, time, and flow velocity of a gas, and the drying speed may be changed by varying these conditions during drying.

When a contact treatment of the solid with a ruthenium compound is performed by a contact treatment of the solid with a solution containing a ruthenium compound and a solvent, the dried product obtained after the drying treatment is preferably subjected to second calcination in an oxidizing gas atmosphere after retention in a state of containing 1.0 to 15% by weight of the solvent based on the weight of the solid. The retention is performed in a state where evaporation of the solvent contained in the dried product is suppressed, and the evaporation rate of the solvent is preferably less than 0.01 g/h per 1 g of the solid, and more preferably 0.001 g/h or less. In such retention, the temperature is preferably 0 to 80° C., and more preferably 5 to 50° C. The retention time is appropriately set according to the content of the solvent and the retention temperature, and is preferably 10 hours or more, and more preferably 15 hours or more. The retention may be performed under closed conditions or opened conditions, or performed in a gas flow, as long as the retention is performed in a state of containing the solvent in the amount of 1.0 to 15% by weight based on the weight of the solid. The retention may be performed in the same device as in the drying treatment, or performed by transferring to another container after drying.

When a contact treatment of the solid with a ruthenium compound is performed a contact treatment of the solid with a solution containing a ruthenium compound and a solvent, and then the mixture containing the ruthenium compound, the solvent, and the solid obtained after the contact treatment is dried until the content of the solvent becomes 0.10 to 15% by weight based on the weight of the solid, if the content of the solvent becomes 0.10% by weight or more and less than 1.0% by weight based on the weight of the solid during drying, the retention may be performed after adjusting the content of the solvent in the dried product within a range of 1.0 to 15% by weight based on the weight of the solid by a method in which a gas containing a vaporized solvent is allowed to flow to thereby bring into contact with the dried product before the retention, or a method in which the mixture is left to stand in the atmosphere when the solvent is water.

The supported ruthenium compound is converted into ruthenium oxide by second calcination in the oxidizing gas atmosphere. The oxidizing gas is a gas containing an oxidizing substance, and examples thereof include an oxygen-containing gas. The oxygen concentration is usually about 1 to 30% by volume. Air and pure oxygen are usually used as this oxidizing gas. If necessary, the oxidizing gas may be diluted with an inert gas and steam. The oxidizing gas is preferably air. The calcination temperature is usually 100 to 500° C., and preferably 200 to 400° C.

When the retention is performed, drying may be further performed until the content of the solvent in the dried product becomes less than 1.0% by weight based on the weight of the solid, after retention, followed by the second calcination, or a reduction treatment may be performed after retention, followed by the second calcination, or drying may be performed until the content of the solvent in the dried product becomes less than 1.0% by weight based on the weight of the solid after retention, followed by a reduction treatment and further the second calcination. A conventionally known method can be employed as such drying method, and the temperature is usually from room temperature to about 100° C. and the pressure is usually 0.001 to 1 MPa, and preferably atmospheric pressure. Such drying can be performed in an air atmosphere, or in an inert gas atmosphere such as nitrogen, helium, argon, or carbon dioxide, and the inert gas may contain steam. Examples of such reduction treatment include reduction treatments mentioned in JP 2000-229239 A, JP 2000-254502 A, JP 2000-281314 A, JP 2002-79093 A, and the like.

A supported ruthenium oxide including ruthenium oxide and silica supported on a titania carrier can be produced by supporting a ruthenium compound on a solid including the above-mentioned silica on a titania carrier, followed by second calcination in an oxidizing gas atmosphere. The oxidation number of ruthenium in the supported ruthenium oxide is usually +4 and ruthenium oxide is ruthenium dioxide (RuO₂), and ruthenium having the other oxidation number or ruthenium oxide in the other form may also be contained.

The content of silica of the supported ruthenium oxide obtained by the production method of the present invention varies depending on physical properties of titania to be used, and the content of ruthenium oxide in the obtained supported ruthenium oxide, and is preferably 0.01 to 10% by weight, and more preferably 0.1 to 5% by weight.

The supported ruthenium oxide obtained by the production method of the present invention is preferably used as a molded body. Examples of the shape include a spherical granular shape, a columnar shape, a pellet shape, an extrusion shape, a ring shape, a honeycomb shape, or a granular shape having an appropriate size obtained by pulverization and screening after molding. Of these, a pellet shape is preferred. In this case, the diameter of the molded body is preferably 5 mm or less. Too large diameter of the molded body may sometimes lead to a decrease in conversion rate when used as an oxidation reaction catalyst. There is no particular limitation on the lower limit of the diameter of the molded body. Too small diameter may lead to large pressure loss in a catalyst layer, so that a molded body having a diameter of 0.5 mm or more is usually used. The diameter of the molded body as used herein means a diameter of a sphere for a spherical granular shape, a diameter of a circular cross-section for a columnar shape, or a maximum diameter of a cross-section for other shapes.

The molding may be performed on the preparation of a titania carrier, or performed after supporting silica on a titania carrier, or performed after supporting ruthenium oxide and silica on a titania carrier. Of these, the molding is preferably performed on the preparation of a titania carrier or after supporting silica on a titania carrier, and more preferably performed on the preparation of a titania carrier. When molding is performed on the preparation of a titania carrier, molding can be performed according to a known method, and it is possible to use, as a molded body of a titania carrier, those obtained by kneading a powder- or sol-shaped titania, followed by molding and further heat treatment. Specifically, the molded body can be prepared by kneading a titania powder or a titania sol with a molding auxiliary such as an organic binder, and water, extruding the kneaded mixture into a noodle, drying and crushing the noodle to obtain a molded body, and subjecting the obtained molded body to a heat treatment in an oxidizing gas atmosphere such as air. The oxidizing gas is a gas containing an oxidizing substance and examples thereof include an oxygen-containing gas, and the like, and the oxygen concentration is usually about 1 to 30% by volume. Air and pure oxygen are usually used as this oxidizing gas and, if necessary, the oxidizing gas may be diluted with an inert gas and steam. The oxidizing gas is preferably air. Examples of the inert gas include nitrogen, helium, argon, carbon dioxide, and the like and, if necessary, the inert gas may be diluted with steam. Of these, the inert gas is preferably nitrogen or carbon dioxide. When the heat treatment is performed, the treatment temperature is usually 400 to 900° C., and preferably 500 to 800° C.

In the molded body, the pore volume is preferably 0.15 to 0.40 mL/g, and more preferably 0.15 to 0.30 ml/g. The pore volume of the molded body can be controlled by adjusting the composition of the above-mentioned raw material to be molded, and the heat treatment temperature of the molded body. The pore volume of the molded body can be measured, for example by a mercury penetration method.

Hydrogen chloride in the Mixed gas is oxidized with oxygen by bringing a mixed gas containing hydrogen chloride, oxygen, and a sulfur component into contact with the supported ruthenium oxide, using the thus obtained supported ruthenium oxide as a catalyst. Hydrogen chloride in the mixed gas is oxidized with oxygen to obtain steam and chlorine.

Reaction systems such as a fluidized bed, a fixed bed, and a moving bed can be employed as a reaction system, and a heat insulation-type or heat exchange-type fixed bed reactor is preferred. When using the heat insulation-type fixed bed reactor, both a mono-tubular fixed bed reactor and a multi-tubular fixed bed reactor can be used, and the mono-tubular fixed bed reactor can be preferably used. When using the heat exchange-type fixed bed reactor, both a mono-tubular fixed bed reactor and a multi-tubular fixed bed reactor can be used, and the multi-tubular fixed bed reactor can be preferably used.

Usually, when using the multi-tubular fixed bed reactor, a reactor outlet gas is quickly cooled with water to thereby separate an unreacted hydrogen chloride as hydrochloric acid containing a trace amount of chlorine, together with the thus produced water. There is no particular limitation on the concentration of hydrochloric acid to be separated, and the concentration of hydrochloric acid is usually 1 to 40% by weight, preferably 20 to 40% by weight, and still more preferably 25 to 35% by weight. The thus obtained hydrochloric acid containing chlorine is usually reused by dehydrating and diffusing again as hydrogen chloride, or used as aqueous hydrochloric acid after removing chlorine by stripping. When using as aqueous hydrochloric acid, the amount of residual chlorine in hydrochloric acid is sometimes controlled within a range of 0.01 to 100 ppm by weight.

As the method for quantitative determination of low concentration of residual chlorine in such hydrochloric acid, for example, the following method is exemplified.

A maximum absorbance in an absorption band at a wavelength of 450 nm or more and 500 nm or less of a liquid obtained by mixing a hydrochloric acid solution having the known chlorine concentration with N,N′-bis(2,4-disulfobenzyi)tolidine and/or an alkali metal salt thereof is measured, and a relation formula between the obtained maximum absorbance and the chlorine concentration is determined.

Subsequently, a maximum absorbance in an absorption band at a wavelength of 450 nm or more and 500 nm or less of a liquid obtained by measuring a hydrochloric acid solution containing chlorine to be measured with N,N′-bis(2,4-disulfobenzyl)tolidine and/or an alkali metal salt thereof is measured, and the chlorine concentration is calculated from the obtained maximum absorbance and the relation formula, and then the chlorine concentration in the hydrochloric acid solution containing chlorine is measured.

A hydrochloric acid solution containing chlorine may sometimes contain metal. Examples of the metal include Fe, Cr, Ni, Al, Cu, Zn, Mn, Mg, Ca, Na, and the like. Particularly, even when Fe is contained, it is possible to quantitatively determine chlorine by the above measurement method. The content of the metal in the hydrochloric acid solution is usually about 0.001 to 500 ppm by weight.

After diluting the hydrochloric acid solution containing chlorine by adding water, it is also possible to measure the chlorine concentration in the hydrochloric acid solution. If the chlorine concentration in the hydrochloric acid solution containing chlorine is too decreased by dilution, it may sometimes become difficult to measure the concentration. The pH of the hydrochloric acid solution containing chlorine in the measurement is usually 2 or less, and preferably 1 or less.

Examples of N,N′-bis(2,4-disulfobenzyl)tolidine to be used include a hydrate and a solvate.

Examples of the alkali metal salt of N,N′-bis(2,4-disulfobenzyl)tolidine include a tetrasodium salt, a tetrapotassium salt, a tetralithium salt, and the like of N,N′-bis(2,4-disulfobenzyl)tolidine.

Examples of the method in which N,N′-bis(2,4-disulfobenzyl)tolidine and/or an alkali metal salt thereof is/are added to a hydrochloric acid solution containing chlorine include a method in which N,N′-bis(2,4-disulfobenzyl)tolidine and/or an alkali metal salt thereof is/are directly added to the hydrochloric acid solution, if possible, a method in which a solution containing N,N′-bis(2,4-disulfobenzyl)tolidine and/or an alkali metal salt thereof dissolved therein is added, and the like. Examples of the liquid dissolving N,N′-bis(2,4-disulfobenzyl)tolidine and/or an alkali metal salt include those which dissolve N,N′-bis(2,4-disulfobenzyl)tolidine and/or an alkali metal salt and do not react with chlorine. The addition amount of N,N′-bis(2,4-disulfobenzyl)tolidine and/or an alkali metal salt thereof may be the amount enough to cause the reaction with chlorine in the hydrochloric acid solution after the addition to thereby develop a color, and the concentration of N,N′-bis(2,4-disulfobenzyl)tolidine and/or an alkali metal salt thereof in the hydrochloric acid solution preferably b becomes 0.01 g/L to 1 g/L.

An absorbance of a liquid obtained by mixing a hydrochloric acid solution containing chlorine with N,N′-bis(2,4-disulfobenzyl)tolidine and/or an alkali metal salt thereof usually have a maximum value in an absorption band at a wavelength of 450 nm or more and 500 nm or less.

In order to measure an absorbance of a liquid obtained by mixing a hydrochloric acid solution containing chlorine with N,N′-bis(2,4-disulfobenzyl)tolidine and/or an alkali metal salt thereof, a maximum absorbance in an absorption band at a wavelength of 450 nm or more and 500 nm or less may be measured. Examples of the measurement method include an ultraviolet-visible spectroscopy and an ultraviolet visible near infrared spectroscopy. It is preferred that the absorbance is measured by an ultraviolet-visible spectroscopy using light having a wavelength in an ultraviolet and visible region. The measurement wavelength is usually within a range of 200 to 900 nm, preferably 400 to 800 nm, and still more preferably 400 to 600 nm. Examples of the device to be used in the measurement of the absorbance include usually usable ultraviolet-visible spectrophotometer and ultraviolet-visible near-infrared spectrophotometer.

There is a need to make a relation formula (calibration curve) in advance by a conventional method so as to calculate the chlorine concentration in a hydrochloric acid solution containing chlorine from the measured maximum absorbance. A hydrochloric acid solution having the known chlorine concentration is prepared and a maximum absorbance in an absorption band at a wavelength of 450 nm or more and 500 nm or less of a liquid obtained by mixing the hydrochloric acid solution with N,N′-bis(2,4-disulfobenzyl)tolidine and/or an alkali metal salt is measured, and thus the relation formula (calibration curve) is made from a relation between the obtained maximum absorbance and chlorine concentration. It is particularly preferred that plural hydrochloric acid solutions each having the known different chlorine concentration are prepared and each of the hydrochloric acid solutions is mixed with N,N′-bis(2,4-disulfobenzyl)tolidine and/or an alkali metal salt thereof, and then a maximum absorbance in an absorption band at a wavelength of 450 nm or more and 500 nm or less of the obtained respective liquids is measured and thus the relation formula (calibration curve) is made from a relation between the obtained respective maximum absorbances and chlorine concentrations.

The reaction of oxidation of hydrogen chloride into chlorine using oxygen is an equilibrium reaction and the equilibrium conversion rate decreases if the reaction is performed at too high temperature, so that the reaction is preferably performed at comparatively low temperature. The reaction temperature is usually 100 to 500° C., and preferably 200 to 450° C. The reaction pressure is usually about 0.1 to 5 MPa. Air may be used as an oxygen source, or pure oxygen may be used. Based on hydrogen chloride, the theoretical molar amount of oxygen is ¼ mol, however, 0.1 to 10 times the theoretical amount is usually used. The supplying speed of hydrogen chloride is usually about 10 to 20,000 h−1 in terms of a gas supplying speed per 1 L of the catalyst 1 L (L/h; in terms of 0° C., 0.1 MPa), that is, GHSV.

Examples of the sulfur component include carbonyl sulfide (COS), carbon disulfide (CS₂), sulfur oxide (SO, SO₂, SO₃), hydrogen sulfide (H₂S), sulfuric acid mist, sulfurous acid gas, methyl mercaptan (CH₃SH), ethyl mercaptan (C₂H₅SH), dimethyl sulfide ((CH₃)₂S), diethyl sulfide ((C₂H₅)₂S), dimethyl disulfide (CH₃SSCH₃), elemental sulfur (S), and the like, or two or more of these sulfur components. If the sulfur component contained in the mixed gas is a sulfur component oxidizable with oxygen, such as carbonyl sulfide (COS), carbon disulfide (CS₂), hydrogen sulfide (H₂S), sulfurous acid gas, methyl mercaptan (CH₃SH), ethyl mercaptan (C₂H₅SH), dimethyl sulfide ((CH₃)₂S), diethyl sulfide((C₂H₅)₂S), dimethyl disulfide (CH₃SSCH₃), or elemental sulfur (S), such sulfur component is oxidized with oxygen by contact to obtain oxidation products such as sulfur oxide, steam, and carbon dioxide.

Examples of the derivation of the sulfur component include a sulfur component contained in a residual gas obtained by washing and dehydrating a gas, which is generated by the oxidation reaction of hydrogen chloride into chlorine using oxygen, with concentrated sulfuric acid, followed by separation of chlorine and further recovery, a sulfur component which is mixed into a gas containing hydrogen chloride by-produced when an isocyanate is obtained by reacting amine with phosgene, and the like. If the residual gas is used as at least a part of the mixed gas and the gas containing the by-produced hydrogen chloride is used as a part of the mixed gas, the sulfur component is contained in the mixed gas. Examples of the sulfur component to be mixed into the gas containing the by-produced hydrogen chloride include carbonyl sulfide, hydrogen sulfide, carbon disulfide, and a sulfurous acid gas in carbon monoxide to be used during the synthesis of phosgene; a sulfurous acid gas and a sulfuric acid mist of chlorine which is also a raw material for the synthesis of phosgene; a sulfur component in an amine to be used in isocyanation; and the like. It is considered that almost all of these sulfur components are mixed into isocyanate during the synthesis of isocyanate, and that they are discharged out of the system together with a high boiling point residue, however, a part thereof is mixed into a gas containing hydrogen chloride which is by-product.

The content of the sulfur component relative to hydrogen chloride in the mixed gas is preferably 100 ppm by volume or less, and more preferably 10 ppm by volume or less, based on hydrogen chloride. There is no particular limitation on the lower limit and, usually, when the sulfur component is contained in the amount of 0.001 ppm by volume or more, and preferably 0.01 ppm by volume or more, based on hydrogen chloride, the method of the present invention is advantageously employed. When two or more sulfur components are contained, the total content may be within the above range.

### EXAMPLES

Examples of the present invention will be described below, but the present invention is not limited thereto.

### Example 1

### Preparation of Titania Carrier

A hundred parts of a titania powder [F-1R, manufactured by Showa Titanium Co., LTD., rutile type titania ratio: 93%] was mixed with 2 parts by weight of an organic binder [YB-152A, manufactured by YUKEN KOGYO CO., LTD.] and then 29 parts by weight of pure water and 12.5 parts by weight of a titania sol [CSB, manufactured by Sakai Chemical Industry Co., Ltd., titania content: 40%] were added, followed by kneading. This mixture was extruded into a noodle having a diameter of 3.0 mmφ, dried at 60° C. for 2 hours, and then crushed into a molded body having a length of about 3 to 5 mm. The obtained molded body was heated in air from room temperature to 600° C. over 1.7 hours and calcined by retaining at the same temperature for 3 hours to obtain a white titania carrier [rutile type titania ratio of 90% or more].

### (Supporting of Silica on Titania Carrier)

Sixty point zero (60.0) grams (volume: 46 mL) of the titania carrier obtained above was charged in a 200 mL eggplant-shaped flask, which was set in a rotary impregnation-drying device. While rotating the eggplant-shaped flask containing the titania carrier therein at 80 rpm in a state of being inclined at 60 degrees from a vertical direction, a solution prepared by dissolving 2.13 g of tetraethoxysilane [Si (OC₂H₅)₄, manufactured by Wako Pure Chemical Industries, Ltd.] in 9.22 g of ethanol was added dropwise in the eggplant-shaped flask over 20 minutes to thereby impregnate the titania carrier with the solution. Subsequently, while stirring the titania carrier by rotating the eggplant-shaped flask containing the titania carrier after impregnation at 80 rpm, the temperature inside the eggplant-shaped flask was adjusted to 30° C. and a mixed gas of steam and nitrogen (steam concentration: 2.0% by volume) was continuously supplied into the eggplant-shaped flask at a flow rate of 277 mL/min (in terms of 0° C., 0.1 MPa) for 4 hours and 20 minutes and then allowed to pass through the eggplant-shaped flask to thereby dry the titania carrier after impregnation. A ratio (GHSV) of a supplying speed of the mixed gas to the volume of the titania carrier was 360/h (in terms of 0° C., 0.1 MPa). The obtained dried product (62.3 g) was heated in an air flow from room temperature to 300° C. over 1.2 hours and then calcined by retaining at the same temperature for 2 hours to obtain 60.6 g of a solid including silica on a titania carrier (silica-supported titania carrier). With respect to the obtained silica-supported titania carrier, the content of silica was determined by ICP analysis using ICP emission spectroscopy (IRIS Advantage, manufactured by Nippon Jarrell-Ash Co. Ltd.) and found to be 0.98% by weight (silicon content: 0.46% by weight). A silica fixation rate was calculated from the ICP analytical value of by the following equation. The results are shown in Table 1.

Silica fixation rate (%)=(ICP analytical value (% by weight) of silicon content in silica-supported titania carrier×100)/[(amount (g) of tetraethoxysilane to be used)×(molecular weight of silicon)/(molecular weight of tetraethoxysilane)/(amount (g) of titania carrier to be used)]

### (Production of Supported Ruthenium Oxide)

Thirty point one (30.1) grams (volume: 23.2 mL) of the silica-supported titania carrier obtained above was charged in a 200 mL eggplant-shaped flask, which was set in a rotary impregnation-drying device. While rotating the eggplant-shaped flask containing the silica-supported titania carrier therein at 80 rpm in a state of being inclined at 60 degrees from a vertical direction, an aqueous solution prepared by dissolving 0.71 g (2.86 mmol) of ruthenium chloride hydrate [(RuCl₃.nH₂O, manufactured by FURUYA METAL Co., Ltd., Ru content: 40.75% by weight] in 6.89 g of pure water was added dropwise in the eggplant-shaped flask over 30 minutes to thereby impregnate with the aqueous solution, thus obtaining 37.70 g of a ruthenium chloride support. The moisture content based on the weight of the silica-supported titania carrier contained in the obtained ruthenium chloride support was determined by the following equation and found to be 23.3% by weight.

Moisture content (% by weight) based on weight of silica-supported titania carrier contained in ruthenium chloride support=[(amount (g) of water used for impregnation)+(amount (g) of water contained in ruthenium chloride hydrate used for impregnation)]/(amount (g) of silica-supported titania carrier used for impregnation)×100

Subsequently, while stirring the ruthenium chloride support by rotating the eggplant-shaped flask containing the ruthenium chloride support therein at 80 rpm, the temperature inside the eggplant-shaped flask was adjusted to 35° C. and air was continuously supplied into the eggplant-shaped flask at a flow rate of 692 mL/min (in terms of 0° C., 0.1 MPa) for 3 hours and 40 minutes and then allowed to pass through the eggplant-shaped flask to thereby dry the ruthenium chloride support, thus obtaining 32.21 g of a dried product A. A ratio (GHSV) of a supplying speed of the silica-supported titania carrier contained in the ruthenium chloride support to the volume of the titania carrier was 1,800/h (in terms of 0° C., 0.1 MPa). The moisture content based on the weight of the silica-supported titania carrier contained in the dried product A was determined by the following equation and found to be 5.0% by weight. The drying speed during drying was 0.050 g/h as an evaporation rate of water per 1 g of the silica-supported titania carrier.

Moisture content (% by weight) based on weight of silica-supported titania carrier contained in dried product A=[(amount (g) of water used for impregnation)+(amount (g) of water contained in ruthenium chloride hydrate used for impregnation)−(amount (g) of change in weight before and after drying of ruthenium chloride support)]/(amount (g) of silica-supported titania carrier used for impregnation)×100

The dried product A (32.21 g) obtained above was charged in a sealed container and then retained in a constant temperature bath at 20° C. for 120 hours. The weight of dried product A after retention was 32.21 g. The moisture content based on the weight of the silica-supported titania carrier contained in the dried product A after retention did not change as compared with that before retention, and the evaporation amount of water was 0 g. The dried product A (21.48 g) after retention was heated in an air flow from room temperature to 280° C. over 1.2 hours and then calcined by retaining at the same temperature for 2 hours to obtain 20.34 g of a bluish grey supported ruthenium oxide in which the content of ruthenium oxide is 1.25% by weight and the content of silica is 0.98% by weight.

### (Evaluation of Initial Activity of Supported Ruthenium Oxide)

The supported ruthenium oxide (1.0 g) obtained above was diluted with 12 g of an α-alumina sphere having a diameter of 2 mm [SSA995, manufactured by NIKKATO CORPORATION] and filled in a reaction tube made of nickel (inner diameter: 14 mm), and also 12 g of the same α-alumina sphere as that mentioned above was filled in the gas inlet side of the reaction tube as a preheat layer. A hydrogen chloride gas was supplied at a rate of 0.214 mol/h (4.8 L/h in terms of 0° C., 0.1 MPa), and an oxygen gas was supplied at a rate of 0.107 mol/h (2.4 L/h in terms of 0° C., 0.1 MPa) in the reaction tube under a normal pressure, and then the reaction was performed by heating the catalyst layer to 282 to 283° C. At the time of 1.5 hours after the beginning of the reaction, sampling was performed for 20 minutes by allowing the gas of the reaction tube outlet through an aqueous 30% potassium iodide solution, and then the amount of chlorine formed was measured by an iodometric titration method to thereby determine a formation speed (mol/h) of chlorine. A conversion rate of hydrogen chloride was calculated from this formation speed of chlorine and the above supplying speed of hydrogen chloride by the following equation. The results are shown in Table 1.

Conversion rate (%) of hydrogen chloride=[(formation speed (mol/h) of chlorine)×2/(supplying speed (mol/h) of hydrogen chloride)]×100

### (Stability Test of Supported Ruthenium Oxide Against Sulfur Component)

The supported ruthenium oxide (1.1 g) obtained above was filled in a reaction tube made of quartz (inner diameter: 21 mm). A hydrogen chloride gas was supplied at a rate of 0.67 mol/h (15 L/h in terms of 0° C., 0.1 MPa), an oxygen gas was supplied at a rate of 0.34 mol/h (7.5 L/h in terms of 0° C., 0.1 MPa), and a nitrogen gas containing 300 ppm by volume of carbonyl sulfide (COS) was supplied at a rate of 0.40 L/h in terms of 0° C., 0.1 MPa (5.35×10⁻⁶ mol/h as COS) (COS content to hydrogen chloride: 8 ppm by volume) in the reaction tube under a normal pressure, and then the reaction was performed by heating the catalyst layer to 345 to 355° C. At the time of 92 hours after the beginning of the reaction, sampling was performed for 20 minutes by allowing the gas of the reaction tube outlet through an aqueous 30% potassium iodide solution, and then the amount of chlorine formed was measured by an iodometric titration method to thereby determine a formation speed (mol/h) of chlorine. A conversion rate of hydrogen chloride was calculated from this formation speed of chlorine and the above supplying speed of hydrogen chloride by the equation mentioned in the above evaluation of initial activity, and found to be 15.3%. After completion of the sampling, the reaction was terminated, followed by cooling while supplying a nitrogen gas.

(Evaluation of Activity of Supported Ruthenium Oxide Against Sulfur Component after Stability Test)

One point zero (1.0) grams of 1.1 g of the supported ruthenium oxide subjected to the above stability test against sulfur component was separated and then a conversion rate of hydrogen chloride was determined by the same method as that in the above evaluation of initial activity. The results are shown in Table 1.

### Example 2

### Preparation of Titania Carrier

A white titania carrier was obtained by the same operation as in Example 1 (Preparation of Titania Carrier).

### (Supporting of Silica on Titania Carrier)

(Supporting of Silica on Titania Carrier)

Fifty point zero (50.0) grams (volume: 38.5 mL) of the titania carrier obtained above was charged in a 200 mL eggplant-shaped flask, which was set in a rotary impregnation-drying device. While rotating the eggplant-shaped flask containing the titania carrier therein at 80 rpm in a state of being inclined at 60 degrees from a vertical direction, a solution prepared by dissolving 1.42 g of tetraethoxysilane [Si(OC₂H₅)₄, manufactured by Wako Pure Chemical Industries, Ltd.] in 7.88 g of ethanol was added dropwise in the eggplant-shaped flask over 20 minutes to thereby impregnate the titania carrier with the solution. Subsequently, while stirring the titania carrier by rotating the eggplant-shaped flask containing the titania carrier after impregnation at 80 rpm, the temperature inside the eggplant-shaped flask was adjusted to 30° C. and a mixed gas of steam and nitrogen (steam concentration: 2.5% by volume) was continuously supplied into the eggplant-shaped flask at a flow rate of 115 mL/min (in terms of 0° C., 0.1 MPa) for 9 hours and then allowed to pass through the eggplant-shaped flask to thereby dry the titania carrier after impregnation. A ratio (GHSV) of a supplying speed of the mixed gas to the volume of the titania carrier was 180/h (in terms of 0° C., 0.1 MPa). The obtained dried product (51.3 g) was heated in an air flow from room temperature to 300° C. over 1.2 hours and then calcined by retaining at the same temperature for 2 hours to obtain 50.2 g of a solid including silica on a titania carrier (silica-supported titania carrier). With respect to the obtained silica-supported titania carrier, the content of silica was determined by ICP analysis using ICP emission spectroscopy (IRIS Advantage, manufactured by Nippon Jarrell-Ash Co. Ltd.) and found to be 0.81% by weight (silicon content: 0.38% by weight). A silica fixation rate was calculated from the analytical value of this silica content in the same manner as in Example 1. The results are shown in Table 1.

### (Production of Supported Ruthenium Oxide)

Forty-nine point eight (49.8) grams (volume: 38.3 mL) of the silica-supported titania carrier obtained above was charged in a 200 mL eggplant-shaped flask, which was set in a rotary impregnation-drying device. While rotating the eggplant-shaped flask containing the silica-supported titania carrier therein at 80 rpm in a state of being inclined at 60 degrees from a vertical direction, an aqueous solution prepared by dissolving 1.21 g (4.78 mmol) of ruthenium chloride hydrate [RuCl₃.nH₂O, manufactured by N.E. CHEMCAT CORPORATION, Ru content: 40.0% by weight] in 11.31 g of pure water was added dropwise in the eggplant-shaped flask over 30 minutes to thereby impregnate with the aqueous solution to obtain 62.32 g of a ruthenium chloride support. The moisture content based on the weight of the silica-supported titania carrier contained in the obtained ruthenium chloride support was determined in the same manner as in Example 1 and found to be 23.1% by weight.

Subsequently, while stirring the ruthenium chloride support by rotating the eggplant-shaped flask containing the ruthenium chloride support at 80 rpm, the temperature inside the eggplant-shaped flask was adjusted to 35° C. and air was continuously supplied into the eggplant-shaped flask at a flow rate of 1,154 mL/min (in terms of 0° C., 0.1 MPa) for 4 hours and then allowed to pass through the eggplant-shaped flask to obtain 53.10 g of a dried product B. A ratio (GHSV) of an air supplying speed to the volume of the silica-supported titania carrier contained in the ruthenium chloride support was 1,800/h (in terms of 0° C., 0.1 MPa). The moisture content based on the weight of the silica-supported titania carrier contained in the dried product B was determined in the same manner as in Example 1 and found to be 4.6% by weight. The drying speed during drying was 0.046 g/h as an evaporation rate of water per 1 g of the silica-supported titania carrier.

The dried product B (53.10 g) obtained above was charged in a sealed container and then retained in a constant temperature bath at 20° C. for 120 hours. The weight of the dried product B after retention was 53.05 g. The moisture content based on the weight of the silica-supported titania carrier contained in the dried product B after retention was calculated as 4.5% by weight, and the evaporation rate of water during retention was 8.37×10⁻⁶ g/h per 1 g of the silica-supported titania carrier. Twenty-one point seven seven (21.77) grams of the dried product B after retention was heated in an air flow from room temperature to 280° C. over 1.2 hours and then calcined by retaining at the same temperature for 2 hours to obtain 20.57 g of a bluish grey supported ruthenium oxide in which the content of ruthenium oxide is 1.25% by weight and the content of silica is 0.81% by weight.

(Evaluation of Initial Activity of Supported Ruthenium Oxide, Stability Test against Sulfur Component, Evaluation of Activity against Sulfur Component after Stability Test)

With respect to the supported ruthenium oxides obtained above, the evaluation of initial activity, the stability test against a sulfur component, and the evaluation of activity against a sulfur component after stability test were performed in the same manner as in Example 1. The results are shown in Table 1. In a stability test against sulfur component, at the time of 92 hours after the beginning of the reaction, a conversion rate of hydrogen chloride of a reaction tube outlet gas was determined in the same manner as in Example 1, and found to be 15.6%.

### Example 3

### Preparation of Titania Carrier

A white titania carrier was obtained by the same operation as in Example 1 (Preparation of Titania Carrier).

### (Supporting of Silica on Titania Carrier)

In the same manner as in Example 1 (Supporting of Silica on Titania Carrier), except that the amount of tetraethoxysilane to be used was replaced by 1.06 g, the amount of ethanol to be used was replaced by 10.18 g, and the steam concentration in a mixed gas of steam and nitrogen was replaced by 2.7% by volume, 59.5 g of a silica-supported titania carrier was obtained. With respect to the obtained silica-supported titania carrier, the content of silica was determined by ICP analysis using ICP emission spectroscopy (IRIS Advantage, manufactured by Nippon Jarrell-Ash Co. Ltd.) and found to be 0.43% by weight (silicon content: 0.20% by weight). The silica fixation rate was calculated from the analytical value of this silica content was calculated in the same manner as in Example 1. The results are shown in Table 1.

### (Production of Supported Ruthenium Oxide)

Fifty point two (50.2) grams (volume: 38.6 mL) of the silica-supported titania carrier obtained above was charged in a 200 mL eggplant-shaped flask, which was set in a rotary impregnation-drying device. While rotating the eggplant-shaped flask containing the silica-supported titania carrier therein at 80 rpm in a state of being inclined at 60 degrees from a vertical direction, an aqueous solution prepared by dissolving 1.21 g (4.78 mmol) of ruthenium chloride hydrate [RuCl₃.nH₂O, manufactured by N.E. CHEMCAT CORPORATION, Ru content: 40.0% by weight] in 10.27 g of pure water was added dropwise in the eggplant-shaped flask over 30 minutes to thereby impregnate with the aqueous solution to obtain 61.68 g of a ruthenium chloride support. The moisture content based on the weight of the silica-supported titania carrier contained in the obtained ruthenium chloride support was determined in the same manner as in Example 1 and found to be 20.9% by weight.

Subsequently, while stirring the ruthenium chloride support by rotating the eggplant-shaped flask containing the ruthenium chloride support at 80 rpm, the temperature inside the eggplant-shaped flask was adjusted to 35° C. and air was continuously supplied into the eggplant-shaped flask at a flow rate of 1,154 mL/min (in terms of 0° C., 0.1 MPa) for 3 hours and 45 minutes and then allowed to pass through the eggplant-shaped flask to thereby dry the ruthenium chloride support, thus obtaining 53.37 g of a dried product C. A ratio (GHSV) of an air supplying speed to the volume of the silica-supported titania carrier contained in the ruthenium chloride support was 1,800/h (in terms of 0° C., 0.1 MPa). The moisture content based on the weight of the silica-supported titania carrier contained in the dried product C was determined in the same manner as in Example 1 and found to be 4.3% by weight. The drying speed during drying was 0.044 g/h as an evaporation rate of water per 1 g of the silica-supported titania carrier.

The dried product C (53.37 g) obtained above was charged in a sealed container and then retained in a constant temperature bath at 20° C. for 96 hours. The weight of the dried product C after retention was 53.07 g. The moisture content based on the weight of the silica-supported titania carrier contained in the dried product C after retention was calculated as 3.8% by weight, and the evaporation rate of water during retention was 6.23×10⁻⁵ g/h per 1 g of the silica-supported titania carrier. Five point three two (5.32) grams of the dried product C after retention was heated in an air flow from room temperature to 280° C. over 1.2 hours and then calcined by retaining at the same temperature for 2 hours to obtain 5.04 g of a bluish grey supported ruthenium oxide in which the content of ruthenium oxide is 1.25% by weight and the content of silica is 0.43% by weight.

(Evaluation of Initial Activity of Supported Ruthenium Oxide, Stability Test against Sulfur Component, Evaluation of Activity against Sulfur Component after Stability Test)

With respect to the supported ruthenium oxides obtained above, the evaluation of initial activity, the stability test against a sulfur component, and the evaluation of activity against a sulfur component after stability test were performed in the same manner as in Example 1. The results are shown in Table 1. In a stability test against sulfur component, at the time of 92 hours after the beginning of the reaction, a conversion rate of hydrogen chloride of a reaction tube outlet gas was determined in the same manner as in Example 1, and found to be 12.9%.

### Comparative Example 1

### Preparation of Titania Carrier

A white titania carrier was obtained by the same operation as in Example 1 (Preparation of Titania Carrier).

### (Supporting of Silica to Titania Carrier)

Fifty point zero (50.0) parts by weight of the titania carrier obtained above was impregnated with a solution prepared by dissolving 1.40 parts by weight of tetraethoxysilane [Si(OC₂H₅)₄, manufactured by Wako Pure Chemical Industries, Ltd.] in 7.88 parts by weight of ethanol, followed by drying in the atmosphere at 24° C. for 15 hours. The obtained dried product (20.2 g) was heated in an air flow from room temperature to 300° C. over 1.2 hours and then calcined by retaining at the same temperature for 2 hours to obtain a titania carrier including silica thereon (silica-supported titania carrier). With respect to the obtained silica-supported titania carrier, the content of silica was determined by ICP analysis using ICP emission spectroscopy (IRIS Advantage, manufactured by Nippon Jarrell-Ash Co. Ltd.) and found to be 0.59% by weight (silicon content: 0.28% by weight). A silica fixation rate was calculated from the analytical value of this silica content in the same manner as in Example 1. The results are shown in Table 1.

### Production of Supported Ruthenium Oxide

Fifty point zero parts by weight of the silica-supported titania carrier obtained above was impregnated with an aqueous solution prepared by dissolving 1.18 parts by weight of ruthenium chloride hydrate [RuCl₃.nH₂O, manufactured by FURUYA METAL Co., Ltd., Ru content: 40.75% by weight] in 11.31 parts by weight of pure water, followed by drying in an air atmosphere at 25° C. for 15 hours to obtain a dried product. The obtained dried product was heated in an air flow from room temperature to 280° C. over 1.2 hours, and then calcined by retaining at the same temperature for 2 hours to obtain a bluish grey supported ruthenium oxide in which the content of ruthenium oxide is 1.25% by weight and the content of silica is 0.59% by weight.

(Evaluation of Initial Activity of Supported Ruthenium Oxide, Stability Test against Sulfur Component, Evaluation of Activity against Sulfur Component after Stability Test)

With respect to the supported ruthenium oxides obtained above, the evaluation of initial activity, the stability test against a sulfur component, and the evaluation of activity against a sulfur component after stability test were performed in the same manner as in Example 1. The results are shown in Table 1. In a stability test against sulfur component, at the time of 92 hours after the beginning of the reaction, a conversion rate of hydrogen chloride of a reaction tube outlet gas was determined in the same manner as in Example 1, and found to be 11.3%.

TABLE 1

| | | | | | Comparative |
|---|---|---|---|---|---|
| | | Example 1 | Example 2 | Example 3 | Example 1 |
| Silica- | Steam concentration during | 2.0 | 2.5 | 2.7 | — |
| supported | drying (% by volume) | | | | |
| titania | GHSV during drying (/h) | 360 | 180 | 360 | — |
| carrier | Silica content (% by weight) | 0.98 | 0.81 | 0.43 | 0.59 |
| | Silica fixation rate (%) | 96 | 99 | 84 | 73 |
| Supported | Ruthenium oxide content | 1.25 | 1.25 | 1.25 | 1.25 |
| ruthenium | (% by weight) | | | | |
| oxide | | | | | |
| Reaction | Hydrogen chloride | 7.5 | 8.9 | 8.1 | 9.5 |
| results | conversion rate (%) | | | | |
| | Initial stage: A | | | | |
| | Hydrogen chloride | 6.5 | 6.3 | 6.0 | 5.0 |
| | conversion rate (%) | | | | |
| | After stability test against | | | | |
| | sulfur component: B | | | | |
| | B/A | 0.87 | 0.71 | 0.74 | 0.53 |

As shown in Table 1, the following fact has been found in Examples 1 to 3. When using, as a catalyst, a supported ruthenium oxide prepared by impregnating a titania carrier with tetraethoxysilane, drying in a steam-containing gas flow, calcining in an oxidizing gas atmosphere, impregnating the obtained silica-supported titania carrier with ruthenium chloride, followed by calcination in an oxidizing gas atmosphere, a hydrogen chloride conversion rate is retained in the evaluation of activity before and after a stability test against a sulfur component, and also the catalyst scarcely deteriorates due to the sulfur component and catalytic activity is stably retained over a long period of time, thus satisfactorily enabling continuous oxidation reaction. To the contrary, in Comparative Example 1 in which drying was performed in the atmosphere without passing through a steam-containing gas to prepare a silica-supported titania carrier and a supported ruthenium oxide prepared by using the obtained silica-supported titania carrier was used as a catalyst, the hydrogen chloride conversion rate drastically decreases as compare with Examples 1 to 3 in the evaluation of activity before and after a stability test against a sulfur component, leading to significant deterioration due to the sulfur component. In Examples 1 to 3, the following fact has been found. Since the conversion rate of hydrogen chloride of a reaction tube outlet gas at the time of 92 hours after the beginning of the reaction in a stability test against a sulfur component is higher than that in Comparative Example 1, the supported ruthenium oxides prepared in Examples 1 to 3 exhibit less deterioration of the catalyst due to the sulfur component as compared with the supported ruthenium oxide prepared in Comparative Example 1, and also catalytic activity is stably retained over a long period of time, thus satisfactorily enabling continuous oxidation reaction.

1. A method for producing chlorine, which comprises bringing a mixed gas containing hydrogen chloride, oxygen, and a sulfur component into contact with a supported ruthenium oxide including ruthenium oxide and silica supported on a titania carrier to thereby oxidize hydrogen chloride in the mixed gas with oxygen, wherein the supported ruthenium oxide is obtained by performing a contact treatment of the titania carrier with an alkoxysilane compound, drying in a steam-containing gas flow, performing first calcination in an oxidizing gas atmosphere, performing a contact treatment of the sold including silica supported on the titania carrier with a ruthenium compound, and performing second calcination in an oxidizing gas atmosphere.

2. The method according to claim 1, wherein the space velocity of the steam-containing gas in the titania carrier is 10 to 2,000/h in a standard state during drying.

3. The method according to claim 1, wherein the contact treatment with the ruthenium compound is a contact treatment with a solution containing a ruthenium compound and a solvent and, after the contact treatment with the solution containing a ruthenium compound and the solvent, drying is performed until the content of the solvent becomes 0.10 to 15% by weight based on the weight of the solid, and then the obtained dried product is subjected to the second calcination.

4. The method according to claim 3, wherein the dried product is retained in a state where the solvent is contained in a proportion of 1.0 to 15% by weight based on the weight of the solid, and then the second calcination is performed.

5. The method according to claim 4, wherein an evaporation rate of the solvent is less than 0.01 g/h per 1 g of the solid during retention.

6. The method according to claim 4, wherein the retention is performed for 10 hours or more.
